(19) United States
(12) Patent Application Publication
(10) Pub. No.: US 2003/0088615 A1
(43) Pub. Date: May 8, 2003

(54) Update resolution procedure for a directory server

(76) Inventors: Gordon Good, Mountain View, CA (US); John Merrells, Mountain View, CA (US); Mark C. Smith, Saline, MI (US); Olga Natkovich, Sunnyvale, CA (US); Richard Megginson, Albuquerque, NM (US)

Correspondence Address: ROSENTHAL & OSHA L.L.P., 1221 MCKINNEY AVENUE, SUITE 2800, HOUSTON, TX, 77010, US

(21) Appl. No.: 09/993,938

(22) Filed: Nov. 6, 2001

(51) Int. Cl. G06F 17/60; G06F 15/16

(52) U.S. Cl. 709/203; 705/8

(57) ABSTRACT

A method for resolving updates in a directory server including generating a change sequence number, creating a total ordering of operations by time using the change sequence number, extracting state information from an entry associated with an operation from the total ordering, and computing a new state for the entry using extracted state information and the operation associated with the entry.

### BACKGROUND OF INVENTION

The most fundamental program resident on any computer is the operating system (OS). Various operating systems exist in the market place, including Solaris™ from Sun Microsystems Inc., Palo Alto, Calif. (Sun Microsystems), MacOS from Apple Computer, Inc., Cupertino, Calif., Windows® 95/98 and Windows NT®, from Microsoft Corporation, Redmond, Wash., UNIX, and Linux. The combination of an OS and its underlying hardware is referred to herein as a “traditional platform.” Prior to the popularity of the Internet, software developers wrote programs specifically designed for individual traditional platforms with a single set of system calls and, later, application program interfaces (APIs). Thus, a program written for one platform could not be run on another. However, the advent of the Internet made cross-platform compatibility a necessity and a broader definition of a platform has emerged. Today, the original definition of a traditional platform (OS/hardware) dwells at the lower layers of what is commonly termed a “stack,” referring to the successive layers of software required to operate in the environment presented by the Internet and World Wide Web.

Effective programming at the application level requires the platform concept to be extended all the way up the stack, including all the new elements introduced by the Internet. Such an extension allows application programmers to operate in a stable, consistent environment.

iPlanet™ E-commerce Solutions, a Sun Microsystems|Netscape Alliance, has developed a net-enabling platform shown in FIG. 1 called the Internet Service Deployment Platform (ISDP) (28). ISDP (28) gives businesses a very broad, evolving, and standards-based foundation upon which to build an e-enabled solution.

A core component of the ISDP (28) is iPlanet™ Directory Server (80), a Lightweight Directory Access Protocol (LDAP)-based solution that can handle more than 5,000 queries per second. iPlanet™ Directory Server (iDS) provides a centralized directory service for an intranet or extranet while integrating with existing systems. The term “directory service” refers to a collection of software, hardware, and processes that store information and make the information available to users. The directory service generally includes at least one instance of the iDS and one or more directory client program(s). Client programs can access names, phone numbers, addresses, and other data stored in the directory.

The iDS is a general-purpose directory that stores all information in a single, network-accessible repository. The iDS provides a standard protocol and application programming interface (API) to access the information contained by the iDS. The iDS provides global directory services, meaning that information is provided to a wide variety of applications. Until recently, many applications came bundled with a proprietary database. While a proprietary database can be convenient if only one application is used, multiple databases become an administrative burden if the databases manage the same information. For example, in a network that supports three different proprietary e-mail systems where each system has a proprietary directory service, if a user changes passwords in one directory, the changes are not automatically replicated in the other directories. Managing multiple instances of the same information results in increased hardware and personnel costs.

The global directory service provides a single, centralized repository of directory information that any application can access. However, giving a wide variety of applications access to the directory requires a network-based means of communicating between the numerous applications and the single directory. The iDS uses LDAP to give applications access to the global directory service.

LDAP is the Internet standard for directory lookups, just as the Simple Mail Transfer Protocol (SMTP) is the Internet standard for delivering e-mail and the Hypertext Transfer Protocol (HTTP) is the Internet standard for delivering documents. Technically, LDAP is defined as an on-the-wire bit protocol (similar to HTTP) that runs over Transmission Control Protocol/Internet Protocol (TCP/IP). LDAP creates a standard way for applications to request and manage directory information.

An LDAP-compliant directory, such as the iDS, leverages a single, master directory that owns all user, group, and access control information. The directory is hierarchical, not relational, and is optimized for reading, reliability, and scalability. This directory becomes the specialized, central repository that contains information about objects and provides user, group, and access control information to all applications on the network. For example, the directory can be used to provide information technology managers with a list of all the hardware and software assets in a widely spanning enterprise. Most importantly, a directory server provides resources that all applications can use, and aids in the integration of these applications that have previously functioned as stand-alone systems. Instead of creating an account for each user in each system the user needs to access, a single directory entry is created for the user in the LDAP directory. FIG. 2 shows a portion of a typical directory with different entries corresponding to real-world objects. The directory depicts an organization entry (90) with the attribute type of domain component (dc), an organizational unit entry (92) with the attribute type of organizational unit (ou), a server application entry (94) with the attribute type of common name (cn), and a person entry (96) with the attribute type of user ID (uid). All entries are connected by the directory.

Understanding how LDAP works starts with a discussion of an LDAP protocol. The LDAP protocol is a message-oriented protocol. The client constructs an LDAP message containing a request and sends the message to the server. The server processes the request and sends a result, or results, back to the client as a series of LDAP messages. Referring to FIG. 3, when an LDAP client (100) searches the directory for a specific entry, the client (100) constructs an LDAP search request message and sends the message to the LDAP server (102) (step 104). The LDAP server (102) retrieves the entry from the database and sends the entry to the client (100) in an LDAP message (step 106). A result code is also returned to the client (100) in a separate LDAP message (step 108).

LDAP-compliant directory servers like the iDS have nine basic protocol operations, which can be divided into three categories. The first category is interrogation operations, which include search and compare operators. These interrogation operations allow questions to be asked of the directory. The LDAP search operation is used to search the directory for entries and retrieve individual directory entries. No separate LDAP read operation exists. The second category is update operations, which include add, delete, modify, and modify distinguished name (DN), i.e., rename, operators. A DN is a unique, unambiguous name of an entry in LDAP. The Relative Distinguished Name (RDN) is the name of the actual entry itself, before appending any qualifying names to form the full DN. These update operations allow the update of information in the directory. The third category is authentication and control operations, which include bind, unbind, and abandon operators.

The bind operator allows a client to identify itself to the directory by providing an identity and authentication credentials. The DN and a set of credentials are sent by the client to the directory. The server checks whether the credentials are correct for the given DN and, if the credentials are correct, notes that the client is authenticated as long as the connection remains open or until the client re-authenticates. The unbind operation allows a client to terminate a session. When the client issues an unbind operation, the server discards any authentication information associated with the client connection, terminates any outstanding LDAP operations, and disconnects from the client, thus closing the TCP connection. The abandon operation allows a client to indicate that the result of an operation previously submitted is no longer of interest. Upon receiving an abandon request, the server terminates processing of the operation that corresponds to the message ID.

In addition to the three main groups of operations, the LDAP protocol defines a framework for adding new operations to the protocol via LDAP extended operations. Extended operations allow the protocol to be extended in an orderly manner to meet new marketplace needs as they emerge.

The basic unit of information in the LDAP directory is an entry, a collection of information about an object. Entries are composed of a set of attributes, each of which describes one particular trait of an object. Attributes are composed of an attribute type (e.g., common name (cn), surname (sn), etc.) and one or more values. FIG. 4 shows an exemplary entry (124) showing attribute types (120) and values (122). Attributes may have constraints that limit the type and length of data placed in attribute values (122). A directory schema places restrictions on the attribute types (120) that must be, or are allowed to be, contained in the entry (124).

### SUMMARY OF INVENTION

In general, in one aspect, the invention involves a method for resolving updates in a directory server. The method comprises generating a change sequence number, creating a total ordering of operations by time using the change sequence number, extracting state information from an entry associated with an operation from the total ordering, and computing a new state for the entry using extracted state information and the operation associated with the entry.

In general, in one aspect, the invention involves a directory server. The directory server comprises a supplier server, a consumer server in communication with the supplier server, a plurality of pluggable services that manage replication of data contained within the directory server from the supplier server to the consumer server, and an update resolution procedure used to detect and resolve update conflicts between consumer servers. Replication of data is managed using the update resolution procedure.

In general, in one aspect, the invention involves an apparatus for resolving updates in a directory server. The apparatus comprises means for generating a change sequence number, means for creating a total ordering of operations by time using the change sequence number, means for extracting state information from an entry associated with an operation from the total ordering, and means for computing a new state for the entry using extracted state information and the operation associated with the entry.

Other aspects and advantages of the invention will be apparent from the following description and the appended claims.

### BRIEF DESCRIPTION OF DRAWINGS

FIG. 1 illustrates a block diagram of iPlanet™ Internet Service Development Platform.

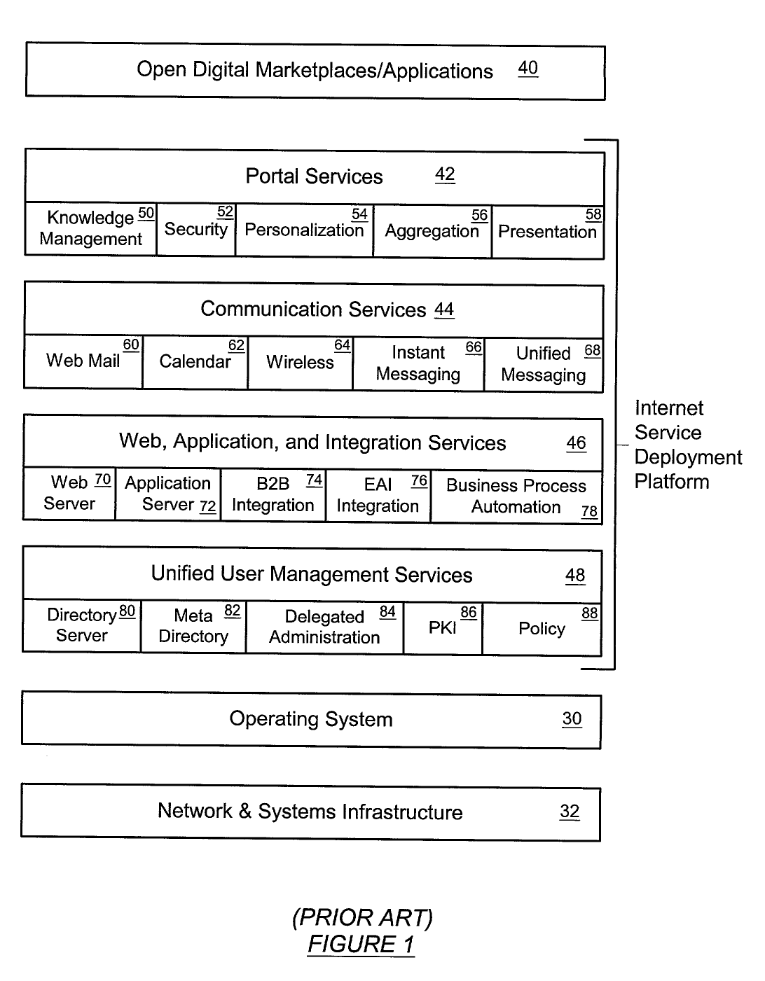

FIG. 2 illustrates part of a typical directory.

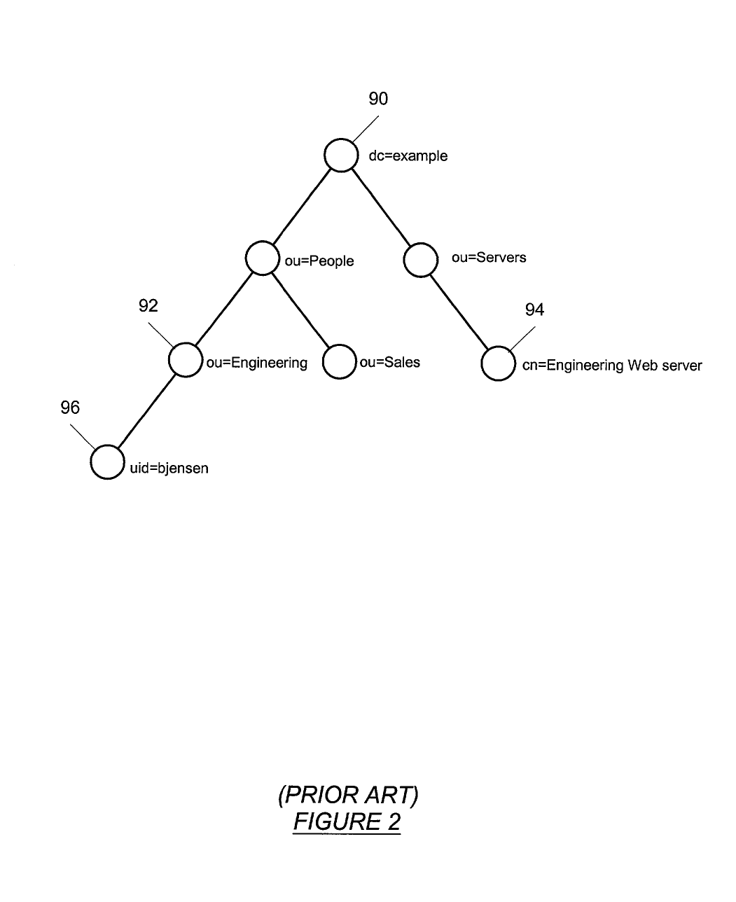

FIG. 3 illustrates the LDAP protocol used for a simple request.

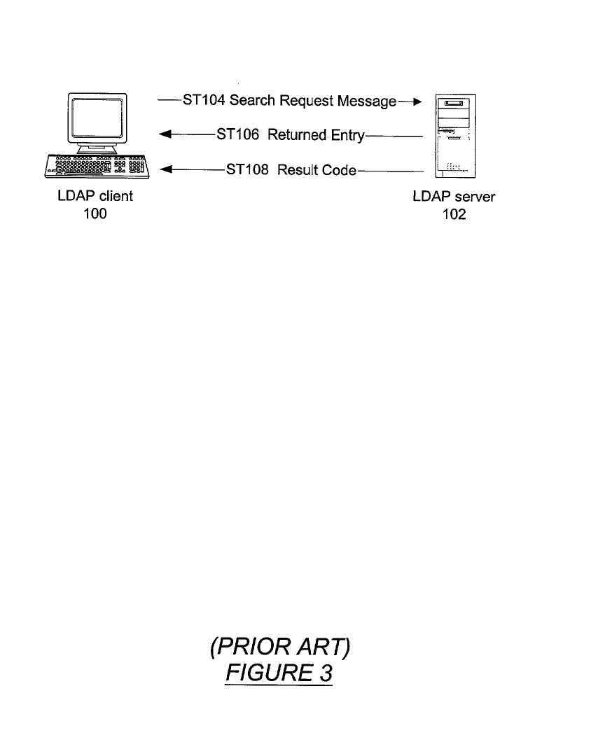

FIG. 4 illustrates a directory entry showing attribute types and values.

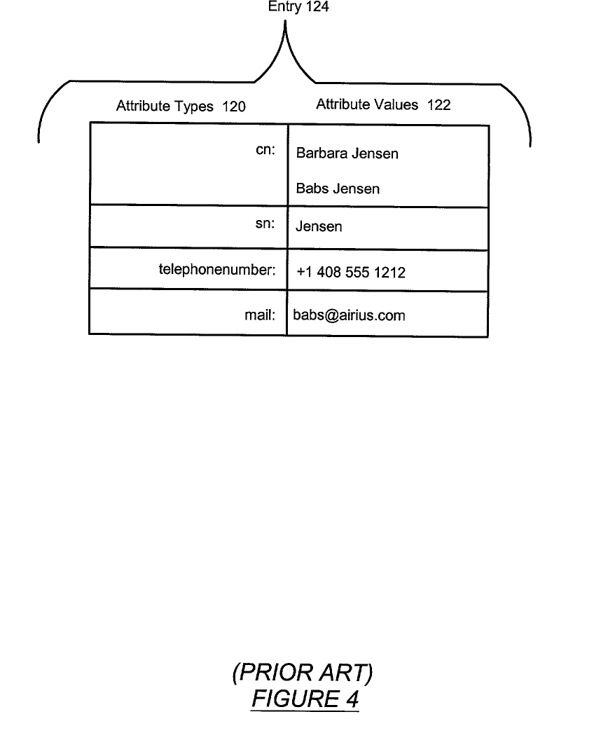

FIG. 5 illustrates a typical computer with components.

FIG. 6 illustrates a representation of entities on a directory server

FIG. 7 illustrates a process to perform update resolution.

FIG. 8A illustrates an initial phase of a collision that occurs when an entry replicated on two different servers receives an Add operation on one server and a delete operation on another server.

FIG. 8B illustrates a second phase of a collision that occurs when an entry replicated on two different servers receives an Add operation on one server and a delete operation on another server.

FIG. 8C illustrates a third phase of a collision that occurs when an entry replicated on two different servers receives an Add operation on one server and a delete operation on another server.

FIG. 8D illustrates a fourth phase of a collision that occurs when an entry replicated on two different servers receives an Add operation on one server and a delete operation on another server.

### DETAILED DESCRIPTION

Specific embodiments of the invention will now be described in detail with reference to the accompanying figures. Like elements in the various figures are denoted by like reference numerals for consistency.

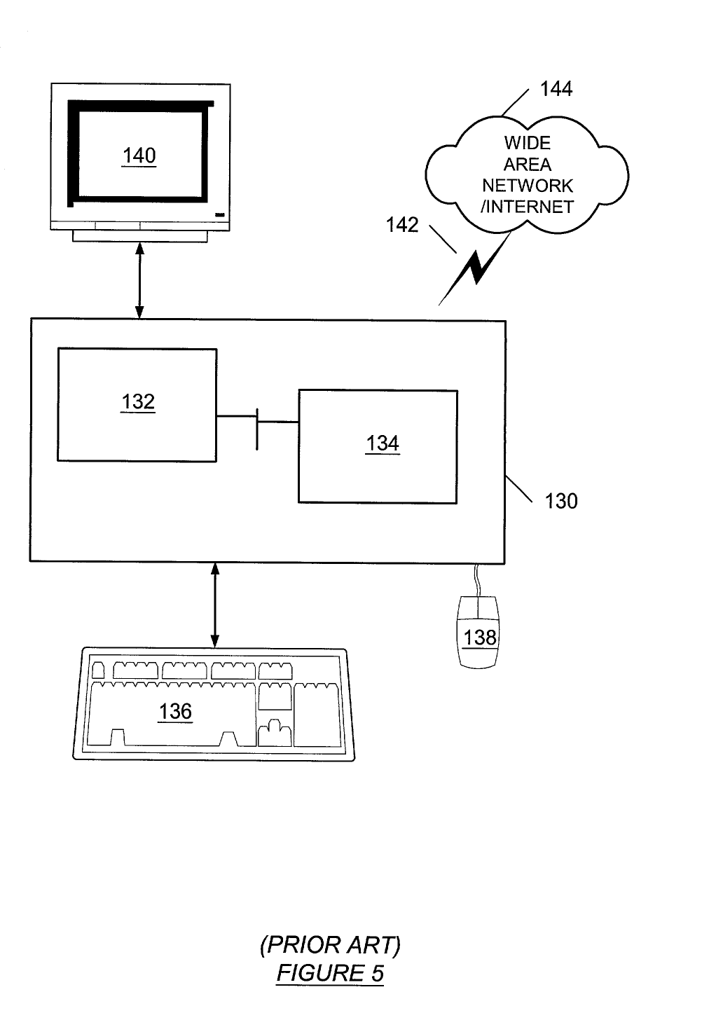

The invention described here may be implemented on virtually any type computer regardless of the traditional platform being used. For example, as shown in FIG. 5, a typical computer (130) has a processor (132), memory (134), among others. The computer (130) has associated therewith input means such as a keyboard (136) and a mouse (138), although in an accessible environment these input means may take other forms. The computer (130) is also associated with an output device such as a display (140), which also may take a different form in a given accessible environment. The computer (130) is connected via a connection means (142) to a wide area network (144), such as the Internet.

Replication is the mechanism that automatically copies directory data from one directory server to another. Replicating a directory's contents increases the availability and performance of the directory and addresses the physical and geographical location of stored data. Using replication serves to copy any directory tree or subtree (stored in a database) between servers. The directory server that holds the master copy of the information, automatically copies any updates to all replicas. Replication enables the provision of a highly available directory service and the geographically distribution of data.

By replicating directory trees to multiple servers, the directory is available even if some hardware, software, or network problem prevents directory client applications from accessing a particular directory server. Clients are referred to another directory server for read and write operations. Note that to support write failover, a multi-master replication environment is needed, where two servers hold a copy of the same read-write replica, and each server maintains a change log for the replica. Modifications made on one server are automatically replicated to the other server. In case of conflict, a time stamp is used to determine which server holds the most recent version. By replicating the directory tree across servers, the access load on any given machine may be reduced, thereby improving server response time. Replication makes it possible to own and manage a set of data locally while sharing the set of data with other directory servers.

A server that holds a replica that is copied to a replica on a different server is called a supplier for that replica. A server that holds a replica that is copied from a different server is called a consumer for that replica. Generally, the replica on the supplier server is a read-write replica, and the replica on the consumer server is a read-only replica.

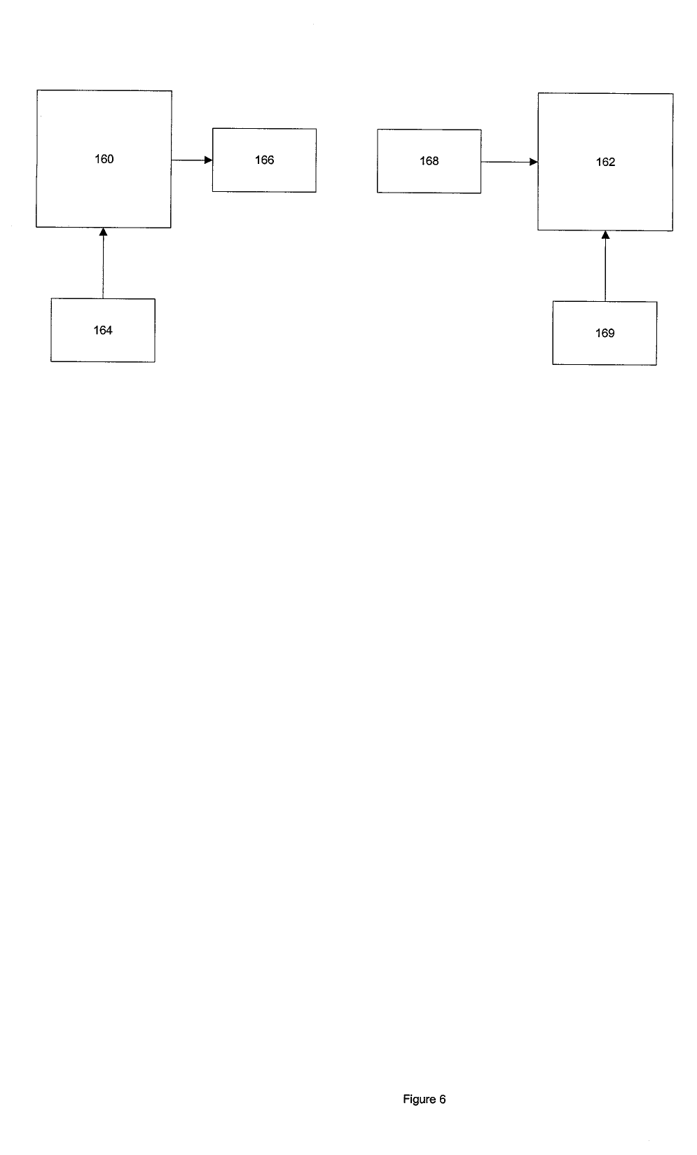

A representation of entities on a directory server is shown in FIG. 6. Masters M (160) and N (162) have clients A (164), B (166), C (168), and D (169). Assume the following facts. All clients have a replica of the same data, and client A (164) modifies the contents of an entry at master M (160). Around the same time, client B (166) modifies the same entry at master N (162). At some later point in time, all the masters and all the replicas attempt to reconcile the changes in the directory contents. An Update Resolution Procedure (URP) is used to determine the correct ordering of various operations. The URP is the process by which update conflicts are detected and resolved. The URP uses the Value Resolution Routine (VRR) to enforce total ordering with respect to the time that operations occur. The update resolution policy of the URP determines the method used to resolve update conflicts. Consistent application of the same URP across all cooperating servers guarantees that eventually all servers contain the same data.

The URP uses Change Sequence Numbers (CSN's) to determine the ordering of the operations. A CSN is a tuple {T, S, r, s} where T is a 32-bit timestamp (UNIX ctime), S is a sequence number used to provide finer granularity than T (16 bits), r is a 16-bit replica ID, and s is a sub-sequence number, used to order operations within a single LDAP operation (16 bits).

In a distributed environment, such as multi-mastered replication, CSN's provide a sense of global logical time and hence a basis for ordering operations which have been initially performed at different servers. The CSN's are assigned to update (add/modify/delete) operations at a replica and are communicated to other replicas via exchange of Replica Update Vectors (RUV's). An RUV describes how up-to-date one replica is with respect to all other replicas. Conceptually, RUV's involve a series of CSN's, one for each known replica, and describes the latest update received from that replica. When one replica sends changes to another, the replica consults the consumer's RUV and determines the smallest set of updates that need to be sent to bring the replica up to date.

State information is stored in the directory database, and on each entry by means of certain unique identifiers, such as tombstones (a tombstone is a copy of a deleted object that may be used to restore the deleted object), entry CSN's, attribute CSN's, and attribute value CSN's, etc. State information becomes obsolete once the operation for the CSN has been replicated to all replicas.

The sequence of operations applied to a single replica are inherently totally ordered by time. When the operation sequences from all replicas within a server topology are combined, they are ordered by time. An OperationCSN is when a time-based CSN is assigned to each operation so that a total ordering may be imposed on the combined sequence.

Each operation is executed immediately without recourse to any centralized ordering coordinator. Thus, the correct ordering is maintained as each operation is applied to the directory. State information is stored with each entry so that a comparison with the operation quickly determines any resultant changes to be applied. State information is recorded for each attribute and each of the attribute's values.

For each attribute, the CSN of the last operation to delete the attribute is stored. An entry with this deletion information may or may not have attribute values. An AttributeDeletionCSN is the attribute necessary to record any previous deletion of attribute values. If an attribute value is present then the CSN of the last operation to update the attribute is stored as a ValueUpdateCSN. If an attribute value has been deleted then the deleted value is stored, as is the CSN of the operation that deleted the attribute, referred to as a ValueDeletionCSN. Note that deleted attribute values are not visible to LDAP clients and are stored just for detecting and resolving update collisions.

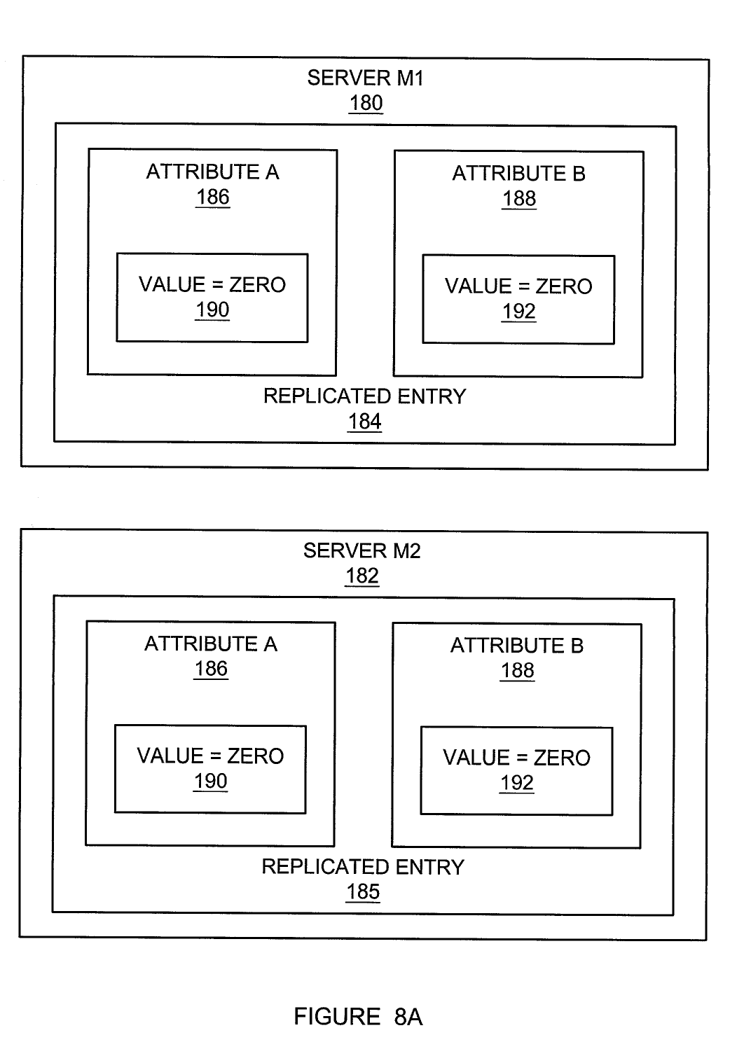

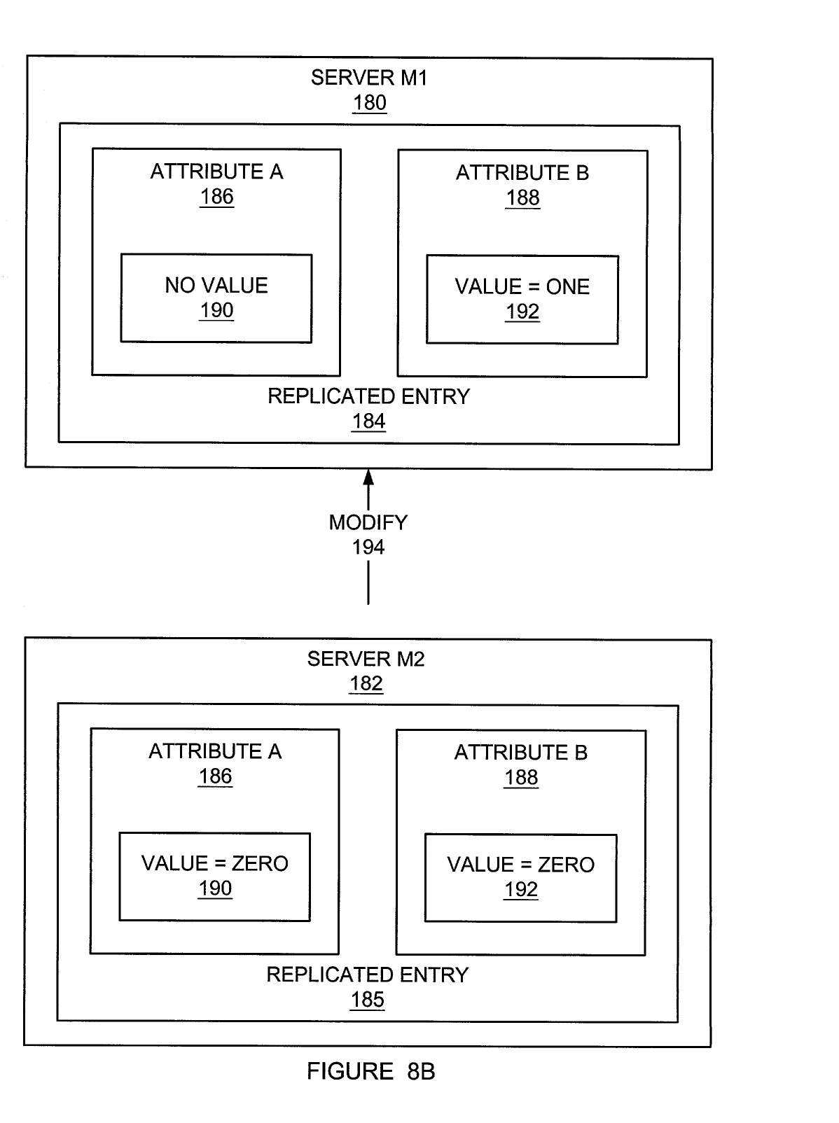

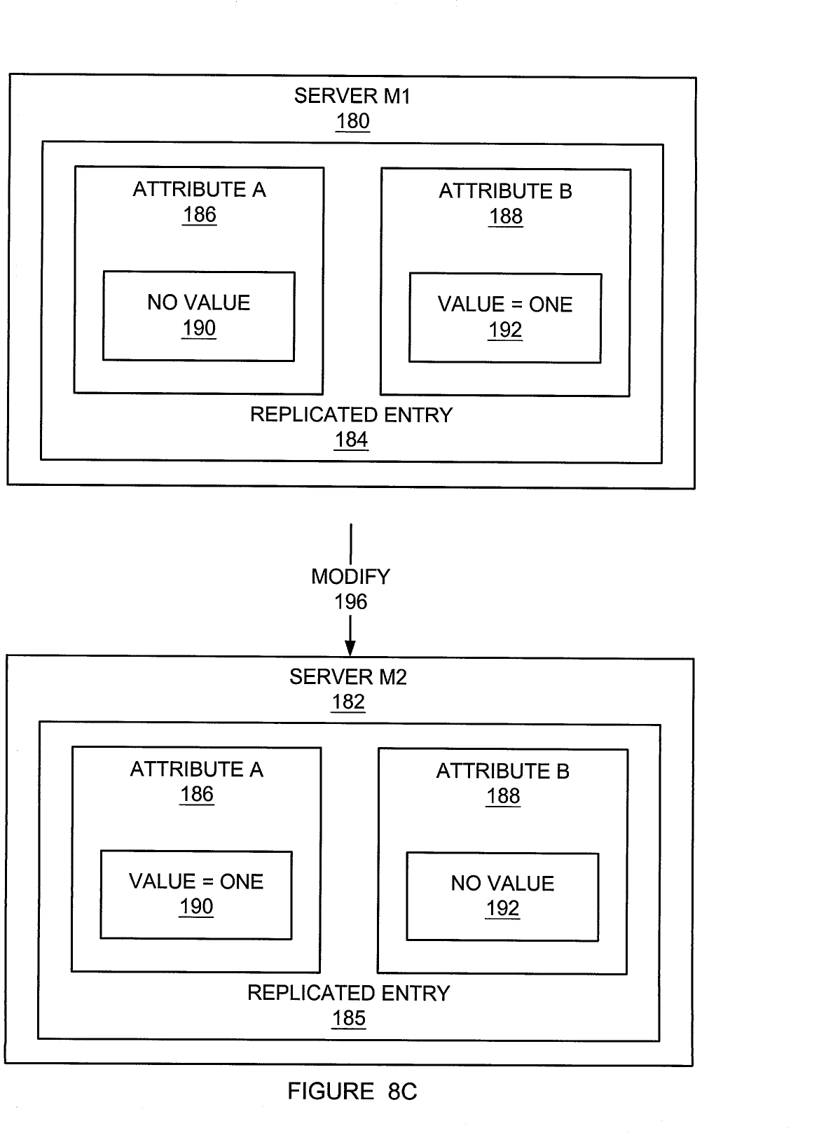

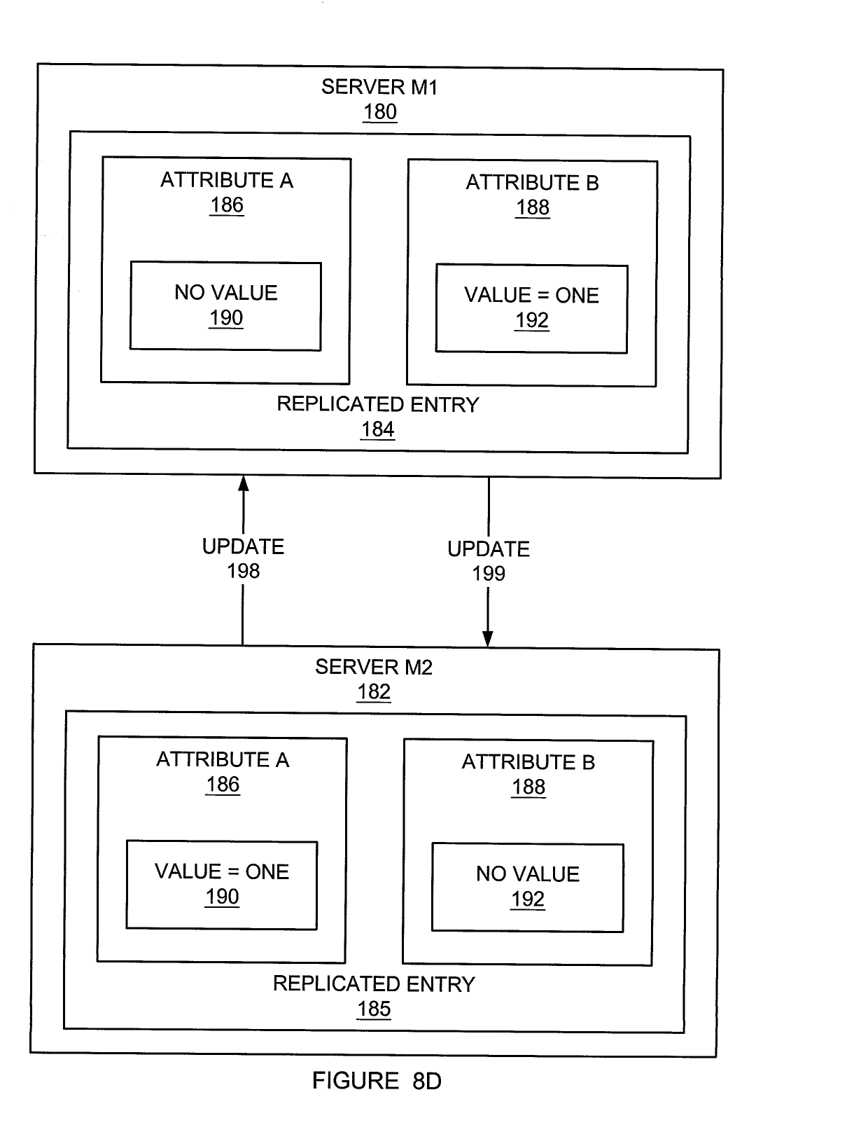

With respect to updates to any replicated entry, conflicts may occur. Such conflicts may be referred to as collisions. An example of a collision that occurs when an entry replicated on two different servers receives an Add operation on one server, and a delete operation on the other server is illustrated in FIG. 8A.

The scenario involves two servers, M1 (180) and M2 (182), that both hold a replicated entry (184, 185), which at time 0 is the same on M1 (180) and M2 (182). The replicated entry (184, 185) has two attributes, A (186) and B (188). A has a single value (190), and B has a single value (192). Both the value (190) of A and the value (192) of B are equal to 0 at time 0.

At time 1, as shown in FIG. 8B, a modify operation (194) is sent to M1 (180) that deletes the value (190) of A (186) and adds the value 1 (192) to B (188).

At time 2, as shown in FIG. 8C, a modify operation (196) is sent to M2 (182) which does the opposite—the value (192) of B (188) is deleted and the value 1 (190) is added for A (186). Therefore, on server M1 (180), attribute B (188) has values 0 and 1 (chronologically), and the value (190) of A (186) has been deleted. Similarly, on M2 (182), A (186) has the values 0 and 1 (190) (chronologically) and the value (192) of B (188) has been deleted.

Then, as shown in FIG. 8D, M1 (180) and M2 (182) replicate. M2 (182) sends an update (198) to M1 (180), and M1 (180) sends an update (199) to M2 (182).

The DN of an entry is also susceptible to operation collisions. A combination of naming operations (e.g., Add and Modify RDN, etc.) at different masters may intertwine during replication to cause two entries to have the same DN. In order to detect these collisions, we also need to store some state information about the name of the entry is stored. Specifically, a DistinguishedNameCSN (DNCSN) is stored, which is the CSN of the last naming operation to change its name. A naming collision occurs when a naming operation causes two distinct entries to collide. To resolve the collision, the OperationCSN is compared with the DNCSN of the entry with the target name. The entry with the oldest name keeps the name, and the entry with the newer name is renamed. The new name becomes the desired name plus the UniqueID of the entry, to ensure the uniqueness of the new name. Naming collisions generate entries that are often manually repaired by the administrator.

The result of a replicated naming operation may cause subordinate entries to become orphaned. This case may occur because of the performance a Delete or a Modify RDN operation on an entry with children. The operation is from a replication source and so must not be rejected, as would be the case if presented by a regular client. The subordinate entries may not be without a superior, so therefore a ‘glue’ entry is created to take the place of the subordinate entries' parent.

The operation plug-in functions implement behavior for LDAP operations. The behavior of certain operation plug-in functions is dependent upon whether the client is a regular LDAP client, or is another server replicating changes to the server. The operation plug-in functions include, but are not limited to AddEntry, DeleteEntry, Compare, Search, Modify, Bind, etc. Those skilled in the art will appreciate that there may be fewer or greater functions than those listed above and that the functions may be called by a variety of names.

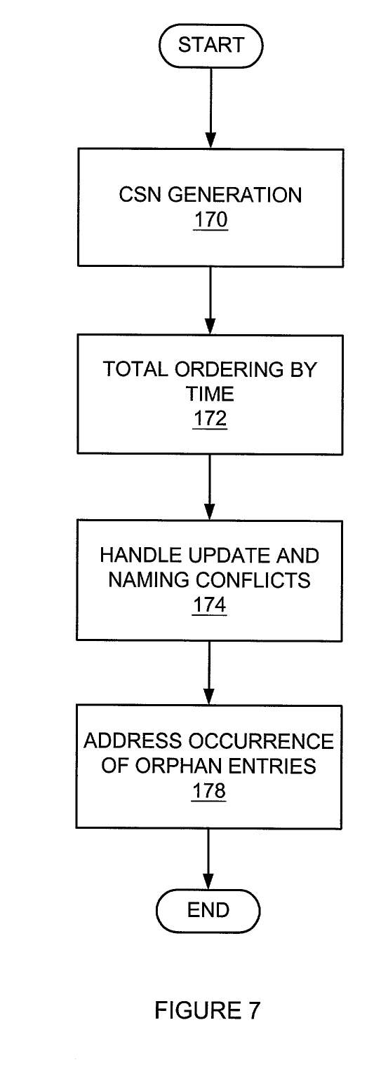

The URP acts, in coordination with other entities, to perform a certain set of steps to perform update resolution, a subset of which is depicted in FIG. 7. Initially, CSN generation is performed (170). Then, a total ordering by time is created (172). Next, update and naming conflicts are handled (174) using a Value Resolution Routine (VRR). The occurrence of orphan entries is also addressed (178). The sequence of the above functions may vary; furthermore, other, additional functions may be handled by the URP.

The VRR takes an operation and an entry and uses the state information to determine the correct resultant state of the entry. The VRR computes the new state of the entry based on the entry's current state and the operation being applied. The main problem addressed by the VRR is the resolution of the conflict between an operation that deletes a value and the operation that makes the value distinguished. The approach taken by the VRR is to consider all operations totally ordered based on CSN of the operation. If, according to the total ordering, the delete operation occurred while the value was distinguished, the delete operation is ignored; otherwise, the value is deleted. In the two examples shown below, the entry under consideration has this initial state, where DN: cn=u; CSN=0; cn={u, v, w}; and CSN=0.

The first example involves two servers. A value is made distinguished on one server and is removed on the other server. The sequence of events is shown below.

| CSN | Operation |
|---|---|
| 1 | rename u->v |
| 2 | delete v |

Because the final state of the entry is computed as though the operations occurred on a single server in the CSN order, the delete operation fails and the value v is present after both operations are applied. However, because the operations may be seen by a server in the reverse order, the server maintains enough state information to detect that the value was deleted while distinguished and restores the value. The second example involves three servers. The entry is renamed by two servers and one of the values is deleted on the third server. The operation sequence is shown below:

| CSN | Operation |
|---|---|
| 1 | rename u->v |
| 2 | rename u->w |
| 3 | delete v |

In the second example above, the delete operation is allowed to proceed, because at the time of the deletion the value v is no longer distinguished, due to the second rename operation. However, because the operations may be seen by a server in any order, the server maintains enough state information to be able to end up with the correct final state.

For the purposes of the VRR, an entry includes a list of all known DN's of that entry, a list of single valued attributes, and a list of multi-valued attributes. Each node of the DN list includes the CSN of the rename operation and the pointers to the values that were made distinguished by the operation. The DN list is sorted in the operation's CSN order. Each attribute of an entry may be either in the present or the deleted state. The attribute state determines whether the attribute is returned in response to a regular LDAP client search request (present attributes are returned, while deleted attributes are not). In addition, a multi-valued attribute includes a set of values and an optional CSN for the last time the attribute was deleted. Each value of a multi-valued attribute includes the attribute state and a set of CSN's. A value of a multi-valued attribute may be set to either the “present” or “deleted” state. As is the case with the attribute, the state of a value determines whether the value is returned in response to a regular LDAP client search request. A single-valued attribute includes two values and an optional deletion CSN identical to the deletion CSN of a multi-valued attribute. A single-valued attribute includes the current value, which is the value that is returned to an LDAP client in response to a search request. In addition, a single valued attribute may include a pending value, which is the value with the largest CSN for this attribute that cannot be made current because the current value was distinguished at the time the new value was added. A value of a single-valued attribute does not have a state; instead, the state is recorded at the attribute level.

The main characteristic of the VRR is that each operation is applied when the operation is received based on the current state of the entry; however, the VRR stores enough state information to fix the state of the entry when further information becomes available. To illustrate, consider the outcome if a server sees the operations in the order listed below:

delete v (CSN=3)

rename u->v (CSN=1)

rename u->w (CSN=2)

When the first operation is received, the value v is deleted because the value is not distinguished at the time. In addition, information about the deletion is recorded in the value. When the first rename operation is received, the deletion is reversed because the rename operation makes the value distinguished at the time of the deletion. Finally, the second rename operation causes the value to be deleted because the operation makes the value non-distinguished at the time of the deletion.

The VRR is implemented as a series of routines that take certain actions when certain operations occur (such as when values are deleted, renamed and made distinguished, etc.).

Advantages of the present invention may include one or more of the following. The URP does not denigrate state information with replicated rename operations that may cause orphan entries. Also, the URP uses a more logical approach with respect to the similarity of the URP behavior to patterns of normal usage of a directory server. Furthermore, changes effected by the URP are better understood by users because of the similarity to patterns found in nature.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for resolving updates in a directory server, comprising:
generating a change sequence number;
creating a total ordering of operations by time using the change sequence number;
extracting state information from an entry associated with an operation from the total ordering; and
computing a new state for the entry using extracted state information and the operation associated with the entry.

2. The method of claim 1, wherein total ordering is enforced by a value resolution routine.

3. The method of claim 1, wherein state information is recorded for an attribute of the entry.

4. The method of claim 3, wherein state information is recorded for a value of the attribute.

5. The method of claim 1, further comprising:
storing state information in the directory server.

6. The method of claim 1, further comprising:
promulgating copies of data by update resolution procedure to a consumer server.

7. The method of claim 1, further comprising:
promulgating copies of data by update resolution procedure to a supplier server.

8. A directory server comprising:
a supplier server;
a consumer server in communication with the supplier server;
a plurality of pluggable services that manage replication of data contained within the directory server from the supplier server to the consumer server; and
an update resolution procedure used to detect and resolve update conflicts between consumer servers;
wherein replication of data is managed using the update resolution procedure.

9. The directory server of claim 9, wherein the update resolution procedure uses an update resolution policy to detect and resolve update conflicts between consumer servers.

10. The directory server of claim 9, wherein the update resolution procedure promulgates copies of data to the consumer server.

11. The directory server of claim 9, wherein the update resolution procedure promulgates copies of data to the supplier server.

12. An apparatus for resolving updates in a directory server, comprising:
means for generating a change sequence number;
means for creating a total ordering of operations by time using the change sequence number;
means for extracting state information from an entry associated with an operation from the total ordering; and
means for computing a new state for the entry using extracted state information and the operation associated with the entry.
